(19) United States
(12) Patent Application Publication
(10) Pub. No.: US 2005/0255296 A1
(43) Pub. Date: Nov. 17, 2005

(54) Desk pad

(76) Inventor: Edward S. Robbins III, Muscle Shoals, AL (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/842,786

(22) Filed: May 11, 2004

(51) Int. Cl. B32B 3/00

(52) U.S. Cl. 428/167; 428/156

(57) ABSTRACT

A transparent desk pad having substantially parallel upper and lower surfaces bounded by a perimeter, the upper surface providing an optically undistorted view of the transparent body lower surface that includes a physically disrupted portion for scattering light incident thereon to create an image such as of affiliation indicia visually perceivable through the upper surface

### BACKGROUND

1. Technical Field

The present invention relates generally to desk pads, and more particularly to desk pads providing affiliation indicia in an attractive manner while also providing a substantially un-disturbed upper working surface and methods for manufacturing such desk pads.

2. General Background

Desk pads that include transparent upper sheets are well known. The upper sheets can take the form of a plate of glass or transparent plastic supported upon, and generally within the outer boundaries of, an underlying, supporting layer of material. The supporting layer is generally disclosed to be opaque and having a lower surface intended to contact and be supported by the top surface of a desk. Any affiliation indicia are generally in the form of printed matter on a separate sheet inserted between the upper sheet and the supporting layer so that the printed matter is visible through the upper sheet. Examples of such structures are to be found in U.S. Pat. Nos. 1,037,607; 1,406,838; 4,292,352; 5,022,170; 5,696,536; 5,727,766; 6,022,599; 6,109,583; and 6,419,495. Affiliation indicia has been applied by printing directly onto one or more surfaces of the pad using silk screen or other techniques with the printed portions being generally protected by a transparent over-layer. Examples of such structures are to be found in U.S. Pat. Nos. 443,205; 4,409,280; 5,270,087; 5,128,194; 5,942,995; 5,997,995; and 6,644,695. Additionally, textured surfaces have been created on either the top surface or on intermediate surfaces to interact with computer related devices such as a mouse. Examples of such structures are to be found in U.S. Pat. Nos. 4,834,502 and 6,383,607.

There remains a need for a transparent desk pad that does not hide the beauty of the wood or other surface of the desk on which it is used, yet incorporates affiliation indicia in an attractive manner while also providing a substantially un-disturbed upper working surface.

### BRIEF SUMMARY

A desk pad of the present invention is intended for use on a desk work surface. The pad has a transparent body of polymeric material having substantially parallel upper and lower surfaces bounded by a perimeter. The lower surface of the transparent body is designed to be supported by the desk work surface while the upper surface of the transparent body is sufficiently planar to provide a smooth substitute work surface spaced vertically upward from said desk work surface. The upper surface of the transparent body is also sufficiently glossy to provide an optically undistorted view of the transparent body lower surface as well as the underlying desk work surface. The lower surface includes a physically disrupted portion for scattering light incident thereon to create an image such as of affiliation indicia visually perceivable through the transparent body upper surface.

The polymeric material forming the transparent body can be any suitable polymer such as polyvinylchloride, polycarbonate, cellulose acetate, polystyrene, polypropylene, polyester, ABS, and mixtures thereof. While it is important that the polymeric material be transparent, the polymeric material can be tinted with a color at a level that does not detract from the optical character of the body that permits an undistorted view of the lower surface of the transparent body. The upper surface of the transparent body can include micro texture features to better enable operation of a computer mouse so long as the micro texture features are small enough to not interfere with an undistorted view of the lower surface of the transparent body.

The affiliation indicia or other image created by the physically disrupted portion of the lower surface can be embossed or imprinted into a passing a web of the transparent polymeric material as it passes around the first roller and between a nip defined by at least one adjacent roller with the lower surface of the desk pad in contact with the first roller. Alternatively, the affiliation indicia or other image created by the physically disrupted portion of the lower surface can be embossed or imprinted into a pre-cut pad using a stamp connected to an armature of an RF welder. In either case, the physical disruption of the lower surface should be deep enough to form a clearly visible impression when viewed though the upper surface of the transparent pad, yet shallow enough that the general planarity of the upper surface is not disturbed. While another image can be included on the upper surface of the desk pad, the general size and depth of the image should be selected to not obscure the primary image on the lower surface that is to be viewed through the upper surface of the transparent pad.

Other features and advantages of a desk pad made in accordance with the present invention will become apparent from a consideration of the following description when taken in conjunction with the accompanying drawings.

### BRIEF DESCRIPTION OF THE DRAWINGS

FIG. 1 is a plan view of a desk pad made in accordance with the present invention.

FIG. 2 is a sectional detail view of two regions of the desk pad shown in FIG. 1.

FIG. 3 is a schematic view of a process for manufacturing the desk pads of the present invention.

FIG. 4 is a schematic view of another process for manufacturing the desk pads of the present invention.

### DESCRIPTION OF THE PREFERRED EMBODIMENTS

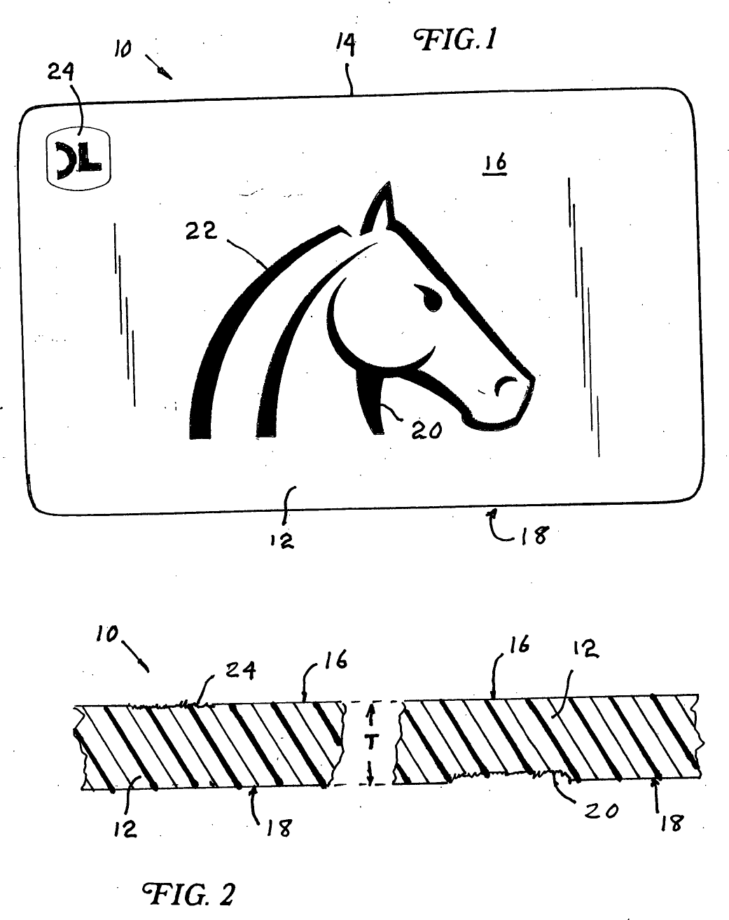

A desk pad 10 of the present invention is shown in FIG. 1 to be formed a transparent body 12 of polymeric material bounded by a perimeter 14. The upper surface 16 of the transparent body is generally planar thus providing a smooth substitute work surface. The upper surface 16 of the transparent body 12 is also sufficiently glossy to provide an optically undistorted view of the transparent body lower surface 18 as well as any underlying desk work surface. Preferably the upper surface 16 has a gloss of at least 70 gloss units. The lower surface 18 includes a physically disrupted portion 20 for scattering light incident thereon to create an image 22, such as of affiliation indicia, visually perceivable through the transparent body upper surface 16. An additional physically disrupted portion 24 is present on the upper surface 16 of the desk pad 10.

The two portions 20 and 24 are shown in the cross-sectional view of the desk pad 10 in FIG. 2. The physically disrupted portion 20 is seen to be present in the lower surface 18 of the pad 10 while the physically disrupted portion 24 is seen to be present in the upper surface 16. The thickness T of the desk pad 10, which is the distance between the upper surface 16 and the lower surface 18, can be selected to be between about 1 and 5 mm, a preferred thickness being about 2 mm. The physical disruptions 20 and 24 preferably take the form of a series or array of adjacent lines indented into the surface of the polymeric body 12. The lines forming the array are preferably parallel lines arranged at about 0.05 to 0.5 mm apart. The lines preferably penetrate into or protrude from the surface 16 or 18 of the polymeric body 12 by a distance which is small in comparison to the thickness T of the desk pad 10.

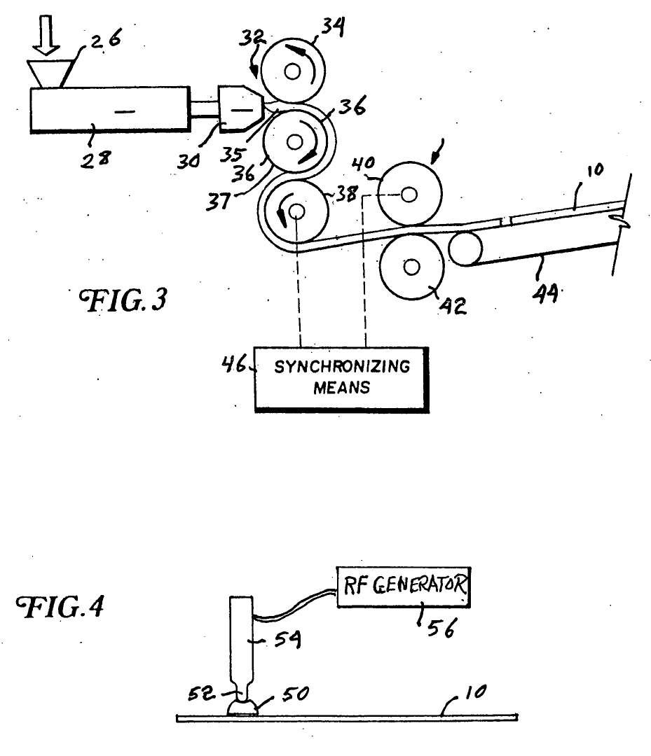

One convenient method for manufacturing the desk pads 10 is illustrated schematically in FIG. 3. A suitable polymer is introduced into inlet 26 of extruder 28 typically in pellet form. The extruder 28 heats and works the polymer in a well know fashion to form a continuous stream of plastic that exits for outlet 30. The outlet 30 is situated adjacent to a nip region 32 between two generally cylindrical rollers 34 and 36. The position of the upper roller 34 with respect to the main roller 36 can be controlled to define the width of the nip region 32 which also controls the thickness T of the desk pads 10 formed by the process. In accordance with the present invention, the main roller 36 includes a surface 37 formed, for example, by engraving or carving, reflecting the image 22 that is desired to be impressed into the lower surface 18 of the desk pad 10. A take-off roller 38 is positioned below the main roller 36 to ensure that the extruded plastic web 35 is retained in contact with the surface 37 of the main roller 36 for sufficient time to freeze the image 22 into the plastic. The upper roller 34 can also include an engraving or carving reflecting the disruption portion 24. The abbreviated contact with the upper roller 34 generally ensures that the disruption portion 24 is indented less than the physical disruption 20 forming the image 22. The take-off roller 38 can also direct the extruded plastic web 35 through a nip between cutting rollers 40 and 42 that can be used to separate the desk pads 10 from each other and any waste portion of the web 35. The position of the cutting rollers 40 and 42 with respect to the image 22 can be controlled by a synchronizing means 46 such as a timing belt or an optical sensor and control. The desk pads 10 can then be conveyed by conveyor 44 for additional processing and packaging, if desired.

One possible additional processing step shown in FIG. 4 wherein a desk pad 10 is contacted by an element 50 having a surface formed, for example, by engraving or carving, reflecting either disruption portion 20 or 24. The element 50 is coupled to an armature 52 of an RF welder 54 that is supplied with a suitable signal from an RF generator 56. The rapid movement induced into the element 50 can be used to form an image in a surface of the desk pad 10.

The foregoing detailed description should be regarded as illustrative rather than limiting, and the following claims, including all equivalents, are intended to define the spirit and scope of this invention.

1. A desk pad for use on a desk work surface, the pad comprising: a transparent body of polymeric material having substantially parallel upper and lower surfaces bounded by a perimeter, the lower surface of the transparent body being designed to be supported by the desk work surface, the upper surface of the transparent body being sufficiently planar to provide a smooth substitute work surface spaced vertically upward from said desk work surface and sufficiently glossy to provide optically undistorted view of the transparent body lower surface; the lower surface including a physically disrupted portion for scattering light incident thereon to create an image visually perceivable through the transparent body upper surface.

2. A desk pad according to claim 1 wherein the physically disrupted surface portion comprises an array of parallel lines arranged at about 0.010 to 0.020 inches apart.

3. A desk pad according to claim 2 wherein each of the lines is indented into the lower surface of the transparent body by about 0.010 to 0.020 inches.

4. A desk pad according to claim 2 wherein each of the lines projects from the lower surface of the transparent body by about 0.010 to 0.020 inches.

5. A desk pad according to claim 1 wherein the body of polymeric material is composed of a plastic selected from polyvinylchloride, polycarbonate, cellulose acetate, polystyrene, polypropylene, polyester, ABS, and mixtures thereof.

6. A desk pad according to claim 1 wherein the upper surface has a gloss of at least 70 gloss units.

7. A desk pad according to claim 1 wherein the upper surface comprises a segment that includes a physically disrupted portion for scattering light incident thereon to create a second visually perceivable image.

8. A desk pad according to claim 7 wherein the physical disruption on the upper surface is indented less than the physical disruption on the lower surface.

9. A desk pad according to any of claims 1 to 7 formed by the process of providing a first roller with a mirror image of said physically disrupted portion, and passing a web of the transparent polymeric material around the first roller and between a nip defined by at least one adjacent roller with the lower surface of the desk pad in contact with the first roller.

10. A desk pad formed by the process of claim 9 wherein the process further comprises providing the second roller with another physically disrupted portion to define an image on the upper surface of the desk pad.

11. A desk pad according to any of claims 1 to 7 formed by the process of providing a stamp with an engraved surface, coupling the stamp to an armature of an RF welder, and contacting a surface of the desk pad with the engraved surface while supplying power to the RF welder.
